(19) United States
(12) Patent Application Publication
(10) Pub. No.: US 2023/0060459 A1
(43) Pub. Date: Mar. 2, 2023

(54) IMAGE OBJECT CLASSIFICATION OPTIMIZING METHOD, SYSTEM AND COMPUTER READABLE MEDIUM

(71) Applicant: Footprintku Inc., Kaohsiung City (TW)

(72) Inventors: Yan-Jhih WANG, Kaohsiung City (TW); Po-Hung LIN, Kaohsiung City (TW); Chia-Ying HSIEH, Kaohsiung City (TW); Yu-Siang FAN JIANG, Kaohsiung City (TW); Jiun-Huei HO, Kaohsiung City (TW)

(21) Appl. No.: 17/463,766

(22) Filed: Sep. 1, 2021

(51) Int. Cl. G06K 9/62; G06T 5/00

(52) U.S. Cl. CPC G06K 9/6227; G06K 9/6263; G06T 5/00

(57) ABSTRACT

An image object classification optimizing method and system are disclosed. The method is executed by a processor coupled to a memory. The method includes steps: providing an image file including at least one image object; performing a process of characteristics enhancement on the image object; performing a process of characteristics classification on the enhanced image object by an odd number of two-dimensional masks whose sizes are sequentially doubled, based on a plurality of characteristic parameters of a preferred classification model, to generate a plurality of classification results; and estimating variabilities of the plurality of classification results, sorting the variabilities, and selecting at least one of the classification results whose variability is lower than a variation tolerance as at least one optimization result, according to the sorting result.

### FIELD OF INVENTION

The present disclosure relates to a classification technology and, specifically to an image object classification optimizing method and system.

### BACKGROUND OF INVENTION

The development and application of machine learning have gradually become an apparent trend. A large amount of data (or information) can be used to train machine learning models, and the trained models can be used to obtain certain prediction information.

Object classification technology is widely used. Many image classification optimizing methods adopt neural networks as a basic architecture, such as classifying digital data generated by converting pictures.

The conventional object classification model usually emphasizes that it can provide a classification result with the highest reliability. However, it will ignore other possible classification results and is not suitable for specific applications.

In light of this, it is necessary to provide a technical solution different from the past to solve a prior art problem.

### SUMMARY OF INVENTION

One objective of the present disclosure is to provide an image object classification optimizing method that can optimize a classification result of image objects and favorably suitable for digital files containing multiple image categories.

Another objective of the present disclosure is to provide an image object classification optimizing system that can optimize a classification result of image objects and favorably suitable for digital files containing multiple image categories.

Another objective of the present disclosure is to provide a tangible, non-transitory, computer readable medium that can optimize a classification result of image objects and favorably suitable for digital files containing multiple image categories.

To achieve the above objective, one aspect of the present disclosure provides an image object classification optimizing method, executed by a processor coupled to a memory, including: providing an image file including at least one image object; performing a process of characteristics enhancement on the image object; performing a process of characteristics classification on the enhanced image object by an odd number of two-dimensional masks whose sizes are sequentially doubled, based on a plurality of characteristic parameters of a preferred classification model, to generate a plurality of classification results; and estimating variabilities of the plurality of classification results, sorting the variabilities, and selecting at least one of the classification results whose variability is lower than a variation tolerance as at least one optimization result according to the sorting result.

In one embodiment of the present disclosure, the process of characteristics classification is performed by three two-dimensional masks with sizes of 13×13, 26×26, and 52×52.

In one embodiment of the present disclosure, before performing the process of characteristics enhancement, the method further includes: converting information of pixels of the image file from a two-dimensional array to a one-dimensional array.

In one embodiment of the present disclosure, the process of characteristics enhancement is performed on the image object converted into the one-dimensional array, through a one-dimensional mask, and a number of elements in the one-dimensional mask is the same as a number of elements in a two-dimensional mask.

In one embodiment of the present disclosure, before converting the information of pixels of the image file from the two-dimensional array to the one-dimensional array, the method further includes: converting the image file from an original size to a compressed size according to a compression ratio.

In one embodiment of the present disclosure, there is a difference interval between the original size and the compressed size of the image file, and the information of pixels in the difference interval is expressed as a specific graphic feature to reform the image file.

In one embodiment of the present disclosure, the plurality of classification results includes a plurality of image categories, and the plurality of image categories includes a plurality of schematic diagrams of characteristics of an electronic component.

Another aspect of the present disclosure provides an image object classification optimizing system including a processor coupled to a memory storing at least one instruction configured to be executed by the processor to perform the above method.

Another aspect of the present disclosure provides a tangible, non-transitory, computer readable medium storing instructions that cause a computer to execute the above method.

The image object classification optimizing method, system, and tangible non-transitory computer readable medium of the present disclosure are provided for providing an image file including at least one image object; performing a process of characteristics enhancement on the image object; performing a process of characteristics classification on the enhanced image object by an odd number of two-dimensional masks whose sizes are sequentially doubled, based on a plurality of characteristic parameters of a preferred classification model, to generate a plurality of classification results; and estimating variabilities of the plurality of classification results, sorting the variabilities, selecting at least one of the classification results whose the variability is lower than a variation tolerance as at least one optimization result according to the sorting result. Thus, after the above object classification optimization process, the classification results of image objects can be effectively optimized, which is beneficial to digital files containing multiple image categories.

### BRIEF DESCRIPTION OF DRAWINGS

FIG. 1 is a schematic diagram of an image object classification optimizing system according to some embodiments of the present disclosure.

FIG. 2 is a flow chart of an image object classification optimizing method according to some embodiments of the present disclosure.

FIG. 3 is a schematic diagram of a first example used for optimizing an image object classification result according to some embodiments of the present disclosure.

FIG. 4 is a schematic diagram of a second example used for optimizing an image object classification result according to some embodiments of the present disclosure.

FIG. 5 is a schematic diagram of a third example used for optimizing an image object classification result according to some embodiments of the present disclosure.

FIG. 6 is a schematic diagram of a fourth example used for optimizing an image object classification result according to some embodiments of the present disclosure.

### DETAILED DESCRIPTION OF EMBODIMENTS

The following description of the various embodiments is provided to illustrate the specific embodiments of the present disclosure. Furthermore, directional terms mentioned in the present disclosure, such as upper, lower, top, bottom, front, rear, left, right, inner, outer, side, surrounding, central, horizontal, lateral, vertical, longitudinal, axial, radial, uppermost, and lowermost, which only refer to the direction of drawings. Therefore, the directional terms configured as above are for illustration and understanding of the present disclosure and are not intended to limit the present disclosure.

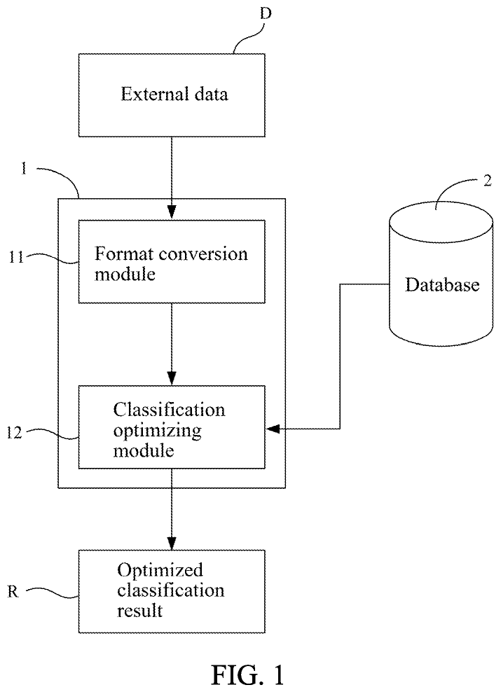

Please refer to FIG. 1, an aspect of the present disclosure that provides an image object classification optimizing system, which can be configured to include a processing device 1 and a database 2. The processing device 1 includes a format conversion module 11 and a classification optimizing module 12 which are coupled to each other. The coupling manner can be a coupling or connection method, such as wired connection, wireless transmission, and data exchange. The database 2 is coupled to the format conversion module 11 and the classification optimizing module 12. The format conversion module 11 and the classification optimizing module 12 can be software modules, hardware modules, or modules that are cooperatively operated by software and hardware. For example, the format conversion module 11 can be configured to have data input, processing, and output functions, such as data reading, calculation, and display, to generate a format conversion result based on an external data D. The classification optimizing module 12 can be configured to have image object classification and optimization functions, to generate at least one optimized classification result R based on the format conversion result. Furthermore, the database 2 can store data, such as characteristic parameters of trained image object classification models and training data.

For example, the image object classification optimizing system may be configured to include a processor and a memory coupled to the processor, wherein the memory stores at least one instruction executed by the processor to perform an image object classification optimizing method provided by another aspect of the present disclosure, which is illustrated as the following but is not limited here.

Another aspect of the present disclosure that provides an image object classification optimizing method that is executed by a processor coupled to a memory and includes: providing an image file, e.g., being converted from a document file, wherein the image file includes at least one image object; performing a process of characteristics enhancement on the image object; performing a process of characteristics classification on the enhanced image object by an odd number of two-dimensional masks whose sizes are sequentially doubled, based on a plurality of characteristic parameters of a preferred classification model, to generate a plurality of classification results; and estimating variabilities of the plurality of classification results, sorting the variabilities, and selecting at least one of the classification results whose variability is lower than a variation tolerance as at least one optimization result according to the sorting result. The following examples illustrate the sample states that can be implemented to understand the relevant content, but not limited here.

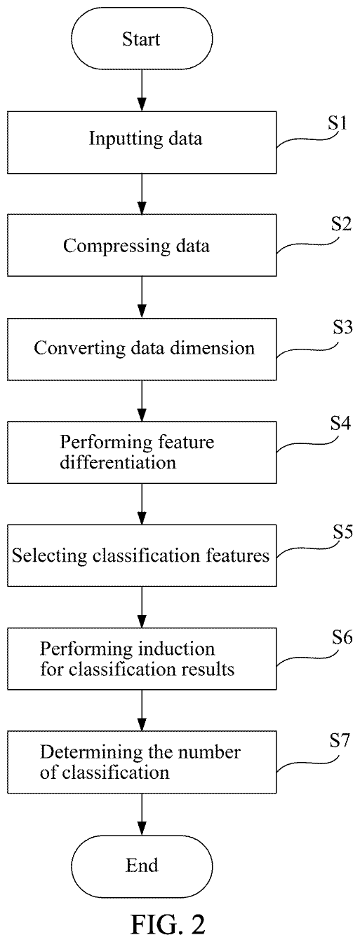

For example, as shown in FIG. 2, the image object classification optimizing method may include steps S1 to S7. At least one part of these steps may be appropriately changed, simplified, or omitted based on actual applications to complete at least one part of the above method embodiment.

As shown in FIG. 2, step S1, may be configured to input external data as a basis for subsequent image object classification. For example, the external data is read. The external 5 data can be an image file. For example, the image file can be provided as pre-filed and stored from a document file by an external machine, but not limited here.

The external data can also be the document file, and the processor can convert the document file to provide the image file. The image file is at least provided in the manner mentioned above and is not limited here. For example, the document file can be a digital document file containing various graphic examples, such as different drawing views of electronic components, and text examples, such as explanatory text. For example, “*. pdf,” a portable document format, e.g., the content of the file can include technical documents (datasheets) related to electronic components, but not limited here.

The digital document file can also be in other file formats, e.g., other file-formats, including graphics and text, such as “*.doc” or “*.odt.” Additionally, the external data can also include other data, such as tables. The image file can be in compressed or uncompressed file format, such as “*.jpg,” but it is not limited here. The image file can also be in other file formats, such as “*.png” or “*.bmp.”

The following image files can refer to file data or screen content in which data of the file is displayed on a display device and can also be called pictures. Subsequently, step S2 can be performed.

Optionally, as shown in FIG. 2, step S2, may be configured to convert the image file from an original size to a compressed size according to a compression ratio. For example, the image file can be compressed into a specific width and a specific height of a frame size based on the compression ratio. There is a difference interval between the original size and the compressed size (that is smaller than the original size) of the image file, and the information of pixels in the difference interval is expressed as a specific graphic feature (such as the spatial range being filled by black pixels) to reform the image file with less data, in which the setting manner is understandable by those skilled in the art. Subsequently, step S3 can be performed.

Optionally, as shown in FIG. 2, step S3, may be configured to convert information of pixels of the image file from a two-dimensional array to a one-dimensional array. For example, the information of pixels of the image file is converted from a two-dimensional array to a one-dimensional array, such as pixels being concatenated one by one (e.g., row by row and column by column) in a two-dimensional image screen. For example, pixels are concatenated from top-left side to bottom-right side in the two-dimensional image screen. Thus, when image data is processed by a computer, an index of the data can be used for processing to speed up a processing speed. Subsequently, step S4 can be performed.

Optionally, as shown in FIG. 2, step S4, may be configured for performing the process of characteristics enhancement on the image object that is converted into a form of the one-dimensional array, by using a one-dimensional mask, and the number of elements in the one-dimensional mask is the same as the number of elements in a two-dimensional mask.

For example, one 1×9 one-dimensional mask can be adopted to replace one 3×3 two-dimensional mask, but not limited here, e.g., the one-dimensional mask can be re-sized to 1×36 for characteristics enhancement of at least one object in the one-dimensional image file according to actual application. For example, information of pixels in one-dimensional array is processed to enhance characteristics in a sliding window manner by using one 1×9 one-dimensional mask.

For example, a layer transfer method in a transfer learning technology can be used, e.g., a pre-train weight method used for object detection may be adopted. For example, coco data set can be adopted as preset parameters of a one-dimensional mask, make the mask more sensitive to detect lines and patterns, so that the mask can effectively highlight the difference between lines, patterns, and image background when the mask slides in the one-dimensional array of the image file, in which the calculating manner is understandable by those skilled in the art. Subsequently, step S5 can be performed.

Optionally, as shown in FIG. 2, step S5, may be configured for selecting a plurality of characteristic parameters of a preferred classification model based on a specific application condition. For example, a plurality of characteristic parameters of one of image object classification models in the database can be selected as a reference of image object classification process, according to the applicability of image objects and a selection condition. For example, a trust score of the object classification is greater than a credibility level, but it is not limited here. In addition, the image object classification models may be machine learning models that are pre-trained. The machine learning models can perform an image object classification process to an image file that is derived from a digital document file containing multiple image objects, to obtain a classification result that implies information of multiple object categories. Subsequently, step S6 can be performed.

An application scenario of electronic components is taken as an example. Schematic diagrams of various features of electronic components can be classified, such as appearance features, electrical features, and application features.

For example, directional views of electronic components may be adopted. Each of the drawing-view diagrams (such as top-view, bottom-view, and side-view) has line segments and geometries for showing the components' size. In addition, pin-assignment diagrams (also called such as pin configurations, pinout diagrams, pin function diagrams etc., e.g., integrated circuit (IC) diagrams showing the feature of pins, hereinafter referred to as IC diagrams) of the electronic components may be adopted. Each of the pin-assignment diagrams of the IC package has geometries showing pins and text.

For example, circuit diagrams may be adopted. For example, the circuit formed by connecting symbols of electronic components has geometric graphs and lines. Also, characteristic curve diagrams may be adopted. For example, characteristic curve diagrams of the voltage or current of electronic components have waveform information formed by continuously extending lines.

For example, signal timing diagrams may be adopted. For example, each of the clock's timing diagrams, input, and output signals of electronic components has a closed block waveform composed of continuously extending lines used to present a continuous waveform relationship. The main difference between the signal timing diagram and the characteristic curve diagram is there are more closed blocks and turning lines, but not limited here.

In addition, other image object classification scenarios, such as a mobile phone manual, may include a schematic diagram of appearance functions and a schematic diagram of screen functions. Graphic characteristics of the mobile phone manual can also be analyzed as a basis for classifying image objects.

As shown in FIG. 2, step S6, may be configured to perform a process of classifying characteristics of the image object that is enhanced, by using odd-numbered two-dimensional masks with sizes that are doubly enlarged in sequence, based on a plurality of characteristic parameters of a preferred classification model, to generate a plurality of classification results.

It should be noted that, by simultaneously using odd-numbered two-dimensional masks with sizes that are doubly enlarged in sequence, such as using three two-dimensional masks with sizes of 13×13 (smaller), 26×26 (medium), and 52×52 (larger), which are not limited here, it is suitable for detecting various image objects in the image file and performing a characteristics classification process to generate the classification results. The various image objects may be larger-sized image objects (such as large tables, IC diagrams, and circuit diagrams), medium-sized image objects (such as drawing-view diagrams, reference signs of size, and small tables), or smaller-sized image objects (such as reference signs of pins, texts, and symbols of electronic components). In addition, the characteristics classification process can be suitable for the above various graphic examples that are possible in various specification documents of electronic components, but is not limited here.

To enable a person to understand the features of embodiments of the present disclosure, the following is an example of inputting a technical file (datasheet) of an electronic component as a document file and illustrates the classification process of the objects in the above embodiments. Still, it is not intended to be used as a limit.

For example, some specification documents of electronic components will be used as examples to illustrate a process that three two-dimensional masks with dimensions of 13×13, 26×26, and 52×52 are adopted to detect image objects in the specification documents of electronic components.

An example of method may include compressing pictures that need to be detected and classified, wherein the compressed pictures' size is 512×512 pixels, there are 35,000 pictures in a data set, and the proportion of the object's size is shown in Table 1 as below.

TABLE 1
Picture Object Information

| object size | used | object size | | |
|---|---|---|---|---|
| definition | mask size | (range) | amount | proportion |
| small object | 13 × 13 | object size < | 9100 | 26% |
| | | 32 × 32 pixels | | |
| medium object | 26 × 26 | 32 × 32 pixels ≤ | 12250 | 35% |
| | | object size < | | |
| | | 96 × 96 pixels | | |
| large object | 52 × 52 | object size > | 13650 | 39% |
| | | 96 × 96 pixels | | |

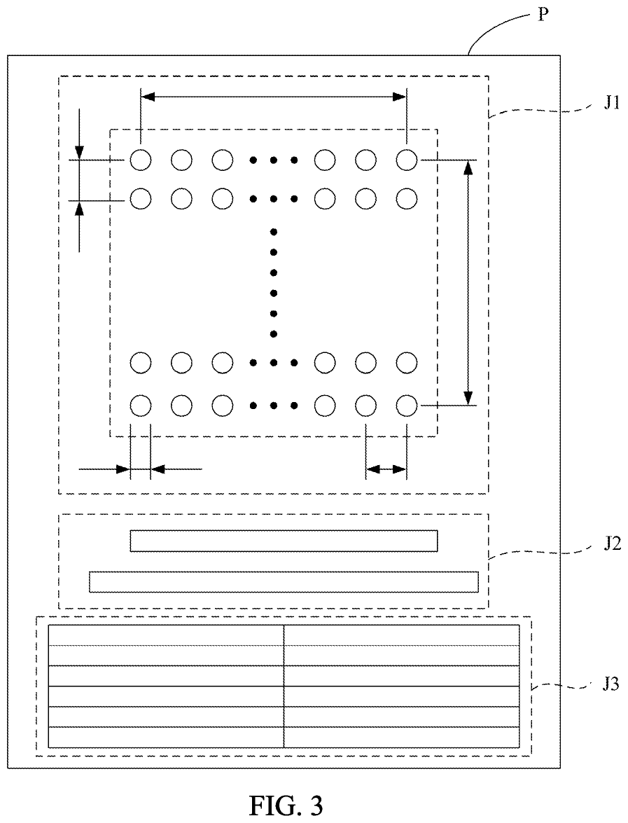

Please refer to FIG. 3, in a picture of image file P, there is a range of IC diagram J1, a range of explanatory text J2, and a range of table J3. The object results that objects are detected by different masks are illustrated as follows, but not limited here.

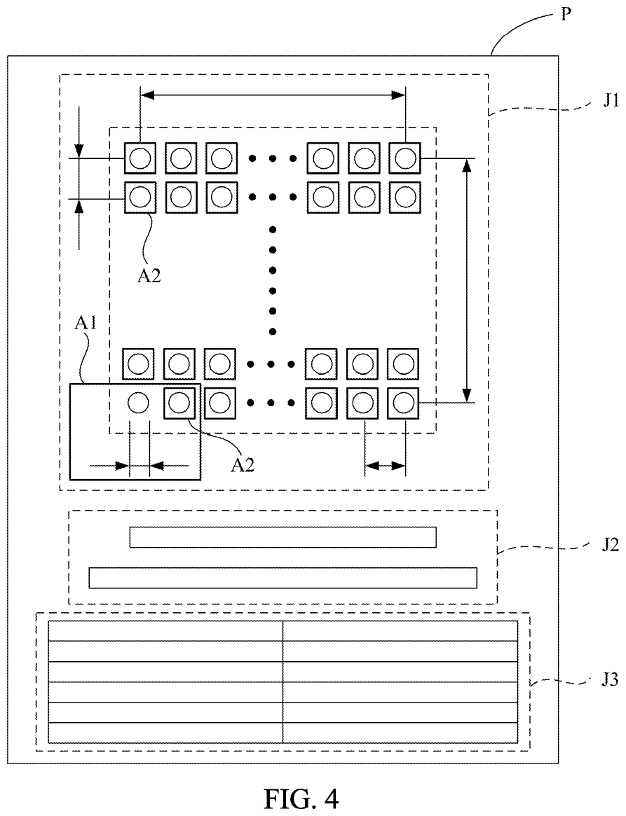

First, a 13×13 two-dimensional mask is taken as an example for detecting smaller objects and finer features in the picture shown in FIG. 3. The 13×13 mask is better has better ability to detect smaller objects in the picture, and can be used to assist in finding feature blocks that are missed by other masks, in the picture. For example, the 13×13 two-dimensional mask can be used to detect smaller objects in the picture shown in FIG. 3. As shown in FIG. 4, an object of reference sign of size A1 and a plurality of objects of reference sign of pin A2 can be detected.

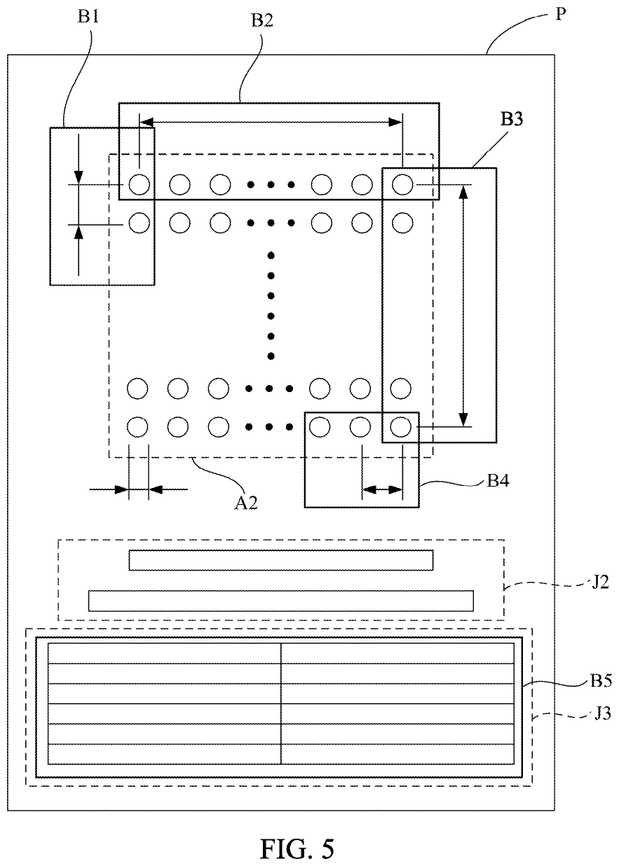

In another aspect, a 26×26 two-dimensional mask is taken as an example being a general-sized mask for detecting medium objects in the picture shown in FIG. 3. The 26×26 mask is better has better ability to detect medium objects in the picture, and is not used for detecting small object by a 13×13 two-dimensional mask and detecting large object by a 52×52 two-dimensional mask. If the detected objects are too fragmented due to a special image content, the detection result of the 26×26 two-dimensional mask can be used as an auxiliary reference for further using 13×13 or 52×52 mask detection. The advantages of this mask are that is can upwardly assist the large objects detection and downwardly assist the small objects detection. For example, the 26×26 two-dimensional mask can be used to detect medium objects, such as those objects which can be detected by the 26×26 two-dimensional mask, in the picture shown in FIG. 3. As shown in FIG. 5, for example, a plurality of objects of reference sign of size B1, B2, B3, B4, and an object of small table B5 can be detected by the 26×26 two-dimensional mask.

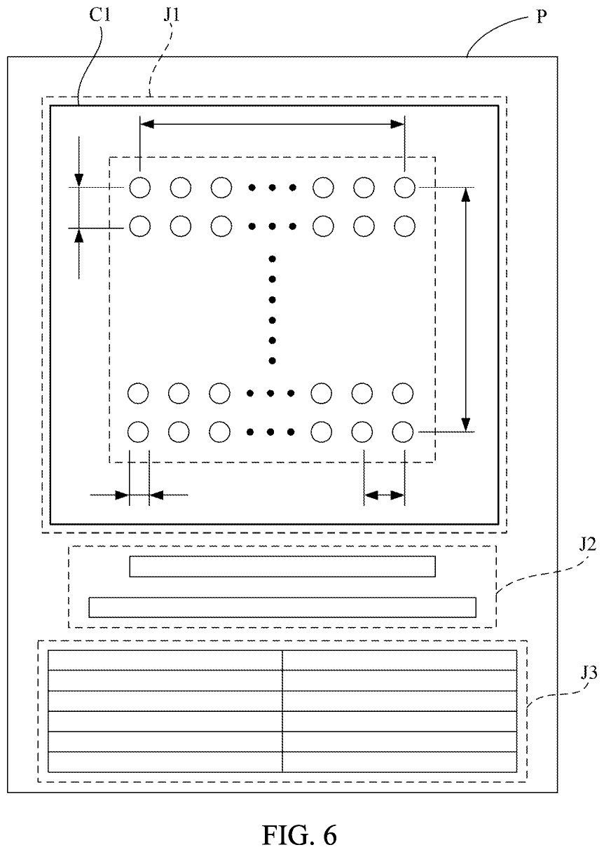

In another aspect, a 52×52 two-dimensional mask is taken as an example for detecting lager objects, so that global features can be seen from the large objects, avoiding a situation where only small features can be detected by a small mask. For example, the 52×52 two-dimensional mask can be used to detect large objects, such as those objects which can be detected by the 52×52 two-dimensional mask, in the picture shown in FIG. 3. As shown in FIG. 6, for example, an object of reference sign of pin C1 can be detected by the 52×52 two-dimensional mask.

It can be understandable from the above examples; the above embodiments of the present disclosure can be used to automatically select objects by a machine. For example, the processed results of the three different sized masks can be combined to avoid using a single mask resulting in the processed results that are too biased. By masks with various sizes, different sized objects in the picture can be detected as an important reference for subsequent variability analysis.

As shown in FIG. 2, step S7, may be configured to estimate variabilities of the classification results and sorting the variabilities, to select at least one of the classification results in which the variability value is less than a variation tolerance, according to a sorted result, as at least one optimization result. For example, the classification results imply information of multiple image objects (such as an attribute name of each of categories, an object location, and an object size) and classification-trusted levels (such as value ranges of all categories are independent and between 0 and 1, Sigmoid[0:1]). The classification results can show the number (e.g., ranging from 3 to 5) or percentage (e.g., ranging from 5 to 10%) of some categories with higher classification-trusted levels of all classification categories, but are not limited here, and can be adjusted according to actual application conditions.

It should be noted that, by estimating a plurality of variabilities of the classification results, it can be known that adopting variabilities of the odd-numbered classification results, such as variabilities of the classification-trusted levels, generated by simultaneously using odd-numbered (e.g., three) two-dimensional masks with different sizes. The variabilities of the classification-trusted levels can be sorted. According to a quality condition, such as selected by a variation tolerance value from a large amount of variability statistics data, e.g., take any value in a range from 1×10⁻² to 1×10⁻⁴ as a threshold, such as 1×10⁻², 1×10⁻³, 1×10⁻⁴, at least one of the classification results, which variability is less than the variation tolerance value, can be selected as at least one optimization result. For example, there are two of three variabilities lower than the threshold, which means that the classification results are more closer, i.e., more likely to be the desired category. Therefore, the classification results corresponding to these two variabilities can be used as the optimization result.

The above examples illustrate the image object classification optimizing method of the present disclosure, so that embodiments of the present disclosure can be summarized as follows.

Optionally, in one embodiment, the process of characteristics classification is performed by three two-dimensional masks with sizes of 13×13, 26×26, and 52×52. In this way, image objects can be automatically filtered, so that objects with different sizes in the picture can be detected.

Optionally, in one embodiment, before performing the process of characteristics enhancement of the image object, the image object classification optimizing method further includes: converting information of pixels of the image file from a two-dimensional array to a one-dimensional array. In this way, when a computer is used for image data processing, an index of the data can be used for processing to speed up the processing speed.

Optionally, in one embodiment, the process of characteristics enhancement is performed on the image object converted into the one-dimensional array through a one-dimensional mask, and a number of elements in the one-dimensional mask is the same as a number of elements in a two-dimensional mask. In this way, sliding window processing can be performed by the one-dimensional mask, so as to perform the characteristics enhancement operation of the image object.

Optionally, in one embodiment, before converting the information of pixels of the image file from the two-dimensional array to the one-dimensional array, the method further includes: converting the image file from an original size to a compressed size according to a compression ratio. In this way, an image file with less data can be formed for subsequent processing, and the number of pixels to be processed can be reduced, which is beneficial to reduce the amount of calculation and the time required for processing.

Optionally, in one embodiment, there is a difference interval between the original size and the compressed size of the image file, and the information of pixels in the difference interval is expressed as a specific graphic feature to reform the image file. In this way, it can be used in application scenarios that need to process a specific size of image. When information of the pixels of the image file is compressed, the specific size of image (such as the degree that can be used by humans or machines to distinguish the content) can be maintained for batch processing.

Optionally, in one embodiment, the plurality of classification results include a plurality of image categories, and the plurality of image categories includes a plurality of schematic diagrams of characteristics of an electronic component, such as drawing views of electronic components, IC diagrams of the electronic components, circuit diagrams, characteristic curve diagrams, and signal timing diagrams, but are not limited here. In this way, different image categories, such as drawing views of electronic components, IC diagrams of the electronic components, circuit diagrams, characteristic curve diagrams, and signal timing diagrams, can be effectively classified, which is helpful for a related person to accelerate data interpretation, analysis, and related development schedule.

In another aspect, the present disclosure further provides an image object classification optimizing system, which includes a processor coupled to a memory storing at least one instruction configured to be executed by the processor to perform the above-mentioned image object classification optimizing method. The coupling manner can be wired or wireless.

For example, the image object classification optimizing system can be configured as an electronic device with data processing functions. The electronic device can be cloud platform machines, servers, desktop computers, notebook computers, tablets, or smartphones, but is not limited here, to perform the above-mentioned image object classification optimizing method, which is not described here again.

In another aspect, the present disclosure further provides a tangible, non-transitory, computer readable medium, storing instructions that cause a computer to execute operations including: providing an image file including at least one image object; performing a process of characteristics enhancement on the image object; performing a process of characteristics classification on the enhanced image object by an odd number of two-dimensional masks whose sizes are sequentially double, based on a plurality of characteristic parameters of a preferred classification model, to generate a plurality of classification results; and estimating variabilities of the plurality of classification results and sorting the variabilities, and selecting at least one of the classification results whose variability is lower than a variation tolerance as at least one optimization result according to the sorting result.

After the instructions are loaded and executed by the computer, the computer can execute the aforementioned image object classification optimizing method. For example, several program instructions can be implemented by using existing programming languages to implement the above-mentioned image object classification optimizing methods, such as Python combining with Numpy, Matplotlib, and TENSORFLOW packages, but not limited here.

In another aspect, the present disclosure further provides a computer-readable medium, such as an optical disc, a flash drive, or a hard disk, but not limited here. It should be understandable that the computer-readable medium can further be configured as other forms of computer data storage medium, e.g., cloud storage (such as ONEDRIVE, GOOGLE Drive, AZURE Blob, or a combination thereof), or data server, or virtual machine. The computer can read the program instructions stored in the computer-readable medium. After the computer loads and executes the program instructions, the computer can complete the above-mentioned image object classification optimizing method.

In summary, the image object classification optimizing method, system, and tangible non-transitory computer readable medium of the present disclosure are provided for providing an image file including at least one image object; performing a process of characteristics enhancement on the image object; performing a process of characteristics classification on the enhanced image object by an odd number of two-dimensional masks whose sizes are sequentially double, based on a plurality of characteristic parameters of a preferred classification model, to generate a plurality of classification results; and estimating variabilities of the plurality of classification results, sorting the variabilities, and selecting at least one of the classification results whose variability is lower than a variation tolerance as at least one optimization result according to the sorting result. Thus, after the above object classification optimization process, the classification results of image objects can be effectively optimized, which is beneficial to digital files containing multiple image categories.

Although the present disclosure has been disclosed in preferred embodiments, which are not intended to limit the disclosure, those skilled in the art can make various changes and modifications without departing from the spirit and scope of the disclosure. Therefore, the scope of protection of the present disclosure is defined as definitions of the scope of the claims.

What is claimed is:

1. An image object classification optimizing method, executed by a processor coupled to a memory, comprising:
providing an image file including at least one image object;
performing a process of characteristics enhancement on the image object;
performing a process of characteristics classification on the enhanced image object by an odd number of two-dimensional masks whose sizes are sequentially doubled, based on a plurality of characteristic parameters of a preferred classification model, to generate a plurality of classification results; and
estimating variabilities of the plurality of classification results, sorting the variabilities, and selecting at least one of the classification results whose variability is lower than a variation tolerance as at least one optimization result according to the sorting result.

2. The image object classification optimizing method as claimed in claim 1, wherein the process of characteristics classification is performed by three two-dimensional masks with sizes of 13×13, 26×26, and 52×52.

3. The image object classification optimizing method as claimed in claim 1, wherein before performing the process of characteristics enhancement, the method further comprises:
converting information of pixels of the image file from a two-dimensional array to a one-dimensional array.

4. The image object classification optimizing method as claimed in claim 3, wherein the process of characteristics enhancement is performed on the image object converted into the one-dimensional array through a one-dimensional mask, and a number of elements in the one-dimensional mask is the same as a number of elements in a two-dimensional mask.

5. The image object classification optimizing method as claimed in claim 3, wherein before converting the information of pixels of the image file from the two-dimensional array to the one-dimensional array, the method further comprises: converting the image file from an original size to a compressed size according to a compression ratio.

6. The image object classification optimizing method as claimed in claim 5, wherein there is a difference interval between the original size and the compressed size of the image file, and the information of pixels in the difference interval is expressed as a specific graphic feature to reform the image file.

7. The image object classification optimizing method as claimed in claim 1, wherein the plurality of classification results includes a plurality of image categories, and the plurality of image categories includes a plurality of schematic diagrams of characteristics of an electronic component.

8. An image object classification optimizing system, comprising a processor coupled to a memory storing at least one instruction configured to be executed by the processor to perform a method comprising:
providing an image file including at least one image object;
performing a process of characteristics enhancement on the image object;
performing a process of characteristics classification on the enhanced image object by an odd number of two-dimensional masks whose sizes are sequentially doubled, based on a plurality of characteristic parameters of a preferred classification model, to generate a plurality of classification results; and
estimating variabilities of the plurality of classification results, sorting the variabilities, and selecting at least one of the classification results whose variability is lower than a variation tolerance as at least one optimization result, according to the sorting result.

9. A tangible, non-transitory, computer readable medium, storing instructions that cause a computer to execute operations comprising:
providing an image file including at least one image object;
performing a process of characteristics enhancement on the image object;
performing a process of characteristics classification on the enhanced image object by an odd number of two-dimensional masks whose sizes are sequentially double, based on a plurality of characteristic parameters of a preferred classification model, to generate a plurality of classification results; and
estimating variabilities of the plurality of classification results, sorting the variabilities, and selecting at least one of the classification results whose variability is lower than a variation tolerance as at least one optimization result according to the sorting result.
